(19) United States
(12) Patent Application Publication
(10) Pub. No.: US 2010/0024045 A1
(43) Pub. Date: Jan. 28, 2010

(54) METHODS AND APPARATUSES FOR PRIVACY IN LOCATION-AWARE SYSTEMS

(76) Inventors: Manoj R. Sastry, Portland, OR (US); Michael J. Covington, Hillsboro, OR (US); Ram Krishnan, Beaverton, OR (US)

Correspondence Address: SCHUBERT, OSTERRIEDER & NICKELSON, PLLC;c/o CPA Global, P.O. BOX 52050, MINNEAPOLIS, MN, 55402, US

(21) Appl. No.: 11/772,196

(22) Filed: Jun. 30, 2007

(51) Int. Cl. G06F 21/24

(52) U.S. Cl. 726/28; 726/30; 726/26

(57) ABSTRACT

In one embodiment a method is disclosed for accepting and enforcing user selectable privacy settings for context awareness including location awareness data on a computing platform. The method may identify a requestor, assign a privacy setting to the requester then detect a request for location information from the requestor. The method may transmit location information to the requester based on the user selected privacy setting. The user selected privacy setting may have a granularity assigned to each requestor based on a privacy preference and the method may entirely block the location information from being disclosed or the method may modify the granularity/accuracy of the location information based on the privacy setting to report context of an appropriate level of granularity according to the privacy setting configured by the user. Other embodiments are also disclosed.

### FIELD

This document relates to the field of communication devices and more particularly, to methods and apparatuses for privacy in a location-aware systems.

### BACKGROUND

There are many benefits to being able to determine a location of a person or a piece of equipment, however allowing others to determine your location is not always desirable. Global positioning systems (GPS) have enabled equipment to determine their location around the world with extreme accuracy. The benefits of such location-aware systems have become apparent and new uses for such location information are continually being exploited. One trend is to place location-aware engines on mobile computing platforms such as laptops and handheld computers and communication devices. However, GPSs have their drawbacks. For example, GPSs are relatively expensive and GPS performance significantly degrades within buildings because the radio waves that determine the location work best when they travel in a “line of sight” between GPS satellites and the receiving device. GPS satellites transmit low power radio signals that can pass through clouds, glass and plastic, however such signals will not traverse through most solid objects such as building walls, roofs and mountains. Accordingly GPS receivers have a hard time operating among and in buildings. Thus, location-aware systems that use signals other than GPS signals are starting to develop, where signals from non-satellite based communication devices may be utilized to determine location of a user or a device. Non-satellite based location-aware systems include systems that utilize beacons, primitives or signals from ground based wireless networks to determine the devices location.

It can be appreciated that wireless networks are ubiquitous in urban areas. These wireless networks may be a WiFi access point as defined by the ever emerging Institute of Electrical and Electronic Engineers (IEEE) 802.11 specification. New positioning technologies have been created that utilize signals from various wireless networks such as IEEE 802.11 compliant networks. Positioning technology that relies on ground based wireless networks can be extremely low cost, as generally, the hardware can be already in place and free software may be obtained to control the existing hardware to determine and provide location information. Accordingly, an “off the shelf” personal computer will typically have a wireless networking card and a processor that may generate such location or positioning information when the proper software is loaded onto the computer.

As eluded to above privacy issues that surround location-aware systems remain a major concern for manufacturers and consumers alike. This can be true for centralized location aware systems and for location aware-systems that calculate location internally to a specific device, or locally (i.e. using a self contained process that resides on a single platform) without the aid of a centralized system. It can be appreciated that users of a location aware system have privacy concerns. For example, someone who is being stalked, is popular with the paparazzi or does not want to be under surveillance may not want to have location information revealed or would like to control the disclosure of such information. In fact, it appears that privacy and security issues have created a significant barrier to adoption of location based services. Generally, consumers are reluctant to allow an outside party to track their movements even if such tracking provides significant benefits.

### BRIEF DESCRIPTION OF THE DRAWINGS

FIG. 1 depicts an embodiment of a location-aware system with privacy settings;

FIG. 2 is a block diagram of a location-aware system with privacy settings;

FIG. 3 is an illustration of a graphical user interface useable to configure user security settings; and

FIG. 4 depicts a flow diagram regarding operation of a location-aware system with privacy settings.

### DETAILED DESCRIPTION OF EMBODIMENTS

The following is a detailed description of embodiments of the invention depicted in the accompanying drawings. However, the amount of detail offered is not intended to limit the anticipated variations of embodiments, but on the contrary, the intention is to cover all modifications, equivalents, and alternatives falling within the spirit and scope of the present teaching as defined by the appended claims. While specific embodiments will be described below with reference to particular circuit or logic configurations, those of skill in the art will realize that some embodiments of the present document may be implemented with other similar configurations.

Location detection/calculation software can be commonly available and some software can even be free and downloadable over the Internet. Thus, a location-aware engine may be easily created on a computing platform. “Place Lab” can be one example of software that may run on a computing platform and provide location information based on primitives received from networks. This location-aware software may provide low-cost, easy-to-use device positioning for location-enhanced computing applications. Location-aware software may provide positioning data to users worldwide, both indoors and outdoors. This local processing feature has advantages over GPS which typically works well outside, but may not work in dense urban areas.

Location-aware engines may determine their location locally and privately without constant interaction with a central service that calculates and provides location information. Such distributed systems are utilized by trucking firms, badge tracking systems and even mobile phone location services, to track devices where the service provider creates location information at centralized sites and owns the location information of others. A location-aware engine on a device may allow the device, like a notebook, a personal digital assistant (PDA) or cell phone to have location-aware features. These devices may listen for radio beacons locally such as 802.11 compliant access points, GSM cell phone towers, and fixed Bluetooth devices that are seemingly exist nearly everywhere in the environment around us to determine location information internally.

These primitives or beacons transmitted by wireless networks may contain a unique or semi-unique identifier (ID). For example, in an 802.11 compliant network the identifier may be a media access control (MAC) address. Location-aware software may compute a current location by receiving one or more IDs, looking up the ID in a locally stored table to find the associated transmitter's position, and estimating a position of the device in relation to the known position of the transmitter. As stated above, the determination of device's location may be accomplished using primitives transmitted by many existing infrastructures such as GPS, Wireless Access Points (WAP), Cell towers, etc to achieve additional accuracy. The location-aware engine in the device may also utilize algorithms that perform triangulation to compute a device's location using primitives from multiple networks.

Generally, local memory of a WAP may store the MAC ID of the WAP and the MAC ID may be utilized to map a WAP transmitter to location co-ordinates such as latitude longitude coordinates. Such a database that maps MAC IDs to latitude longitude coordinates may be obtained from service providers or wardrivers. Wardriving is the act of mapping wireless network locations by moving past networks and detecting and recording the presence and location of a network. Generally, wardrivers may utilize a GPS device and a wireless card to determine a location of a network with a specific MAC address and create the ID/location database discussed above. In addition ID/location databases may be purchased and downloaded using websites such as WIGLE.com. Wardriving software is also available to consumers over the Internet as shareware. All of these systems tend to lack a comprehensive and user friendly privacy system that regulates what location and other context information is disclosed to others. The disclosed embodiments provide a secure location tracking system that can be user friendly such that users may control their anonymity.

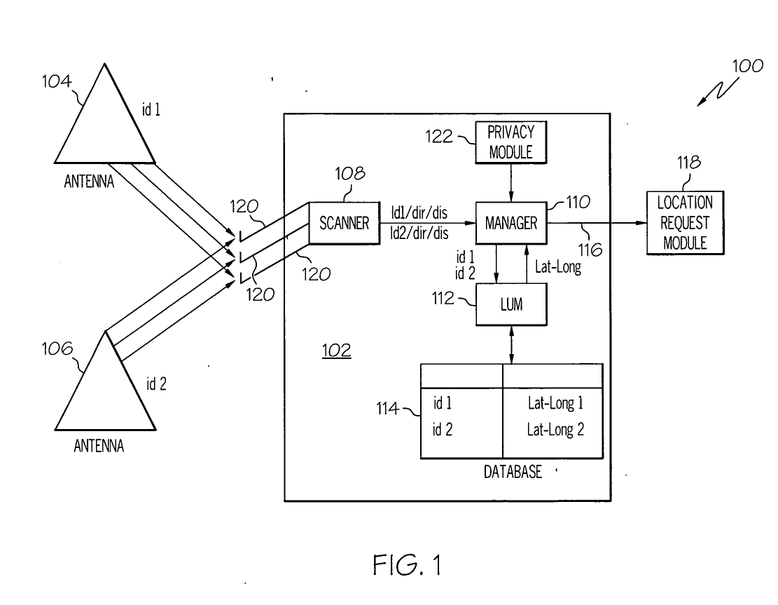

Referring to FIG. 1, a privacy enhanced location-aware system 100 is illustrated. This system could also be referred to as a WiFi based positioning system. Such a positioning system may provide a plurality of benefits to a user including improved Internet search results for location based information. Further, such location based information may be utilized to recover stolen devices particularly for stolen devices with highly confidential or sensitive information. The system 100 may include a scanner 108, a manager/controller 110, a look up module 112, a privacy module 122, and a database 114. The combination of the scanner 108, the manager 110, the look up module 112 and database 114 could be referred to as a location engine 102. The system may receive communication from antennas 104 and 106 and provide filtered location information to computing platform 118 based on user selected privacy settings.

The scanner 108 may be a transceiver that scans for radio transmission on multiple channels, multiple frequencies and multiple paths. The scanner 108 may be very sensitive such that it picks up transmission from a long range even though these signals may not be usable or reliable for network usage as long as the scanner 108 may receive bits and pieces of identification data and direction information over an extended period of time. During operation, the scanner 108 may scan for and receive a radio signal such as beacons or primitives that are transmitted by wireless network antennas 104 and 106. These antennas 104 and 106 may facilitate transmission of wireless signals in accordance with IEEE 802.11 standards or other wireless standards such as those utilized by mobile telephones or even a GPS system.

Such signals or primitives that are periodically sent out by fixed base communication systems such as access points, cellular antennas etc., may be viewed as an “invitation to connect to the network” by the access point. This invitation transmission may include a multitude of signals such as network protocol information and an identifier of the network transmitting the signal. In one embodiment, antennas 104 and 106 are an IEEE 802.11 compliant Wi-Fi access point that periodically transmits beacons that have a media access control identifier (MAC ID) embedded in the transmission.

Scanner 108 may be connected to an antenna array 120 (multiple antennas having a known spacing) and using the signals received from the array 120 the scanner 108 may determine a relative direction that the signal can be coming from and a relative distance, to the antenna (104 and 106), the distance possibly determinable based on signal strength or time delays. Thus, the scanner 108 may scan different channels and frequencies and receive beacons or invitations to connect and may forward many types of information including location and identification information to manager 110. The scanner 108 may also steer the sensitivity of reception using the array 120 to null out noise and increase directional gain to provide a greater sensitivity in a specific direction.

The manager 110 may acquire identifiers from an output of the scanner 108 (signals from transmitting networks via antennas 104 and 106) and provide identification information to look-up module 112. Look up module 112 may utilize the identifiers and the look up table or database 114 (the identifier is shown as a MAC ID in data base 114) to determine latitude-longitude (lat-long) coordinates that relate to the location of source of the transmission received. Thus, the look-up module 112 may return a lat-long output to the manager 110 and based on direction, distance, and ID information the manager 110 may provide location information via input/output line 116 to computing platform 118. Some of this information may not be provided as a primitive or as raw data but some of this may be calculated by the manager 110 using signal strength, time delays and triangulation methods.

The lat-long coordinates and location data may then be utilized by the computing platform 118 such that location based service may be provided. For example, if a consumer can be trying to find directions on the Internet, weather conditions or locate a business and the address, city name or business name provided by the user in a search has ten matches in the United States, the processor 118 may utilize the lat-long information and assume that the user wants the information displayed pertains to the location or is in closest proximity to the access point location(s) that the system 110 has provided to the computing platform 118. It can be appreciated that the system 100 may provide information to computing platform 118 and computing platform 118 may provide better search results among other services and data to the user. The contents of the database 114 may be loaded via a drive, may be downloaded via the Internet or may be acquired by wardriving.

Privacy module 122 may accept user input related to privacy parameters and withhold location information provided to the computing platform 118 based on the user input. The privacy module 122 may mask activities of the system 100 and may identify and manage different requests for the location information that has been created by the system 100. Generally, the privacy module may allow user configurable privacy settings to govern how different requestors of location information are treated based on different privacy settings.

As stated above the scanner module 108 may gather location primitives (e.g. MAC IDs) from existing infrastructure (E.g. WAP/Beacons/cell towers/GPS) and the look-up module 112 may utilize the transmission identifier, the database 114 and a location estimation algorithm and compute a latitude and longitude (or a range) of the platform receiving the signal. In accordance with one embodiment a location engine may compute a platform's location and may provide location privacy based on the privacy module controlling the release of privacy sensitive information.

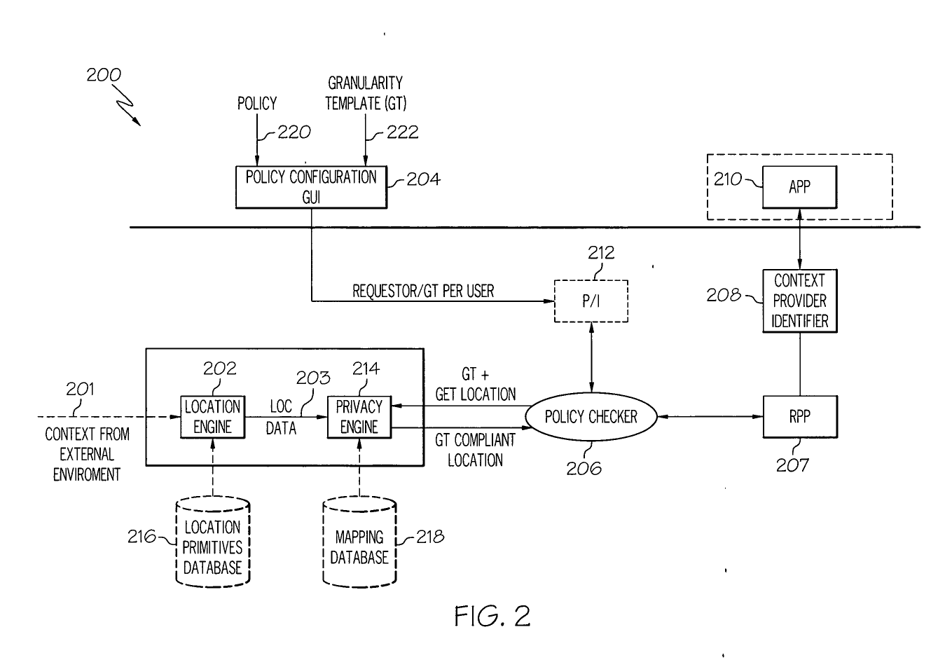

Referring to FIG. 2 a more detailed location-aware system 200 with privacy features is disclosed. The system 200 may include a location engine 202, a privacy policy checker 206, a privacy engine 214, a policy integrator 212, a location database 216, a mapping database 218, a policy configurator 204, a requester properties provider 207 and a context provider 208. The system 200 may interact with, and send location data to an application 210 that could be running on a local or a remote machine.

The location engine 202 may be a system such as that illustrated in FIG. 1 that receives wireless transmissions from input line 210 and provides lat-long data via bus 203 to privacy engine 214. Many location engines are commercially available including “PlaceLab.” In accordance some embodiments, a user may set privacy settings via inputs 220 and 222. Input 220 may accept a basic policy input and input 222 may accept a granularity template input. The requestor properties provider 207 may identify a requestor of location information and provide such identity to the policy checker 206.

The policy configurator 204 may utilize the basic policy input 220 (requestors for example) and the granularity input 222 to control policy integrator 212 which may integrate basic policy input with granularity template input and may control policy checker 206. One function of the policy configurator 204 can be to allow users to configure granularity levels and a privacy policy. The Policy checker 206 may communicate with privacy engine 214 using granularity settings and a get location command. Using these inputs the privacy engine 214 may control release of location information to the application 210. The context provider identifier 208 may permit or deny access to information based on credentials received from a requestor where credentials may include password, user certificates, platform certificates etc.

In some embodiments the granularity template may control the usage of location classifications irrespective of whether an internal or external request has been made for data. The policy checker 206 may release location information to application 210 and possibly service providers or other computers based on the user selected privacy parameters. Thus, the granularity template selected by the user may have many classifications ranging from coarse-grained to fine-grained levels. For example a granularity may be defined in feet, or miles or may be defined as a city, county, state, or country. In one embodiment the granularity may include access not just based on identity but based on a timer or some other decision. For example the platform could be instructed to release Bob's location to colleagues only between 8 AM to 5 PM.

In one embodiment the user may set these preferences or granularity levels such as P1=Country, P2=City, etc. Further, a user could specify locations that are to remain masked such as a home or work locations. The user may utilize such settings to specify a user's location privacy preferences. The privacy engine 214 may provide an output location that can be compliant with the granularity level specified in the policy. The privacy engine 214 may utilize the granularity template 222 and the mapping database 218 to compute location information at or for the requested granularity-level. If the user's granularity settings are not available, the context service provider 208 could provide the default granularity level setting.

One example of a default granularity setting could be P1=Country, P2=P1+City, P3=P2+Street Address, P4=P3+latitude longitude coordinates. An example of a user configured granularity setting could be P1=County, P2=Suburb, P3=Nearby Landmark, and P4=Street Intersection. Thus, the system 200 could restrict release of location information in compliance with user's location privacy preferences or settings.

The policy checker 206 may be the user's policy enforcer. The policy checker 206 may intercept requests from the context provider 208 and check the user configured policy with the information that may be released and block the information or edit the location information based on the location granularity level (E.g. P1=Country) per the user settings. The policy checker 206 may interact with the system 200 to obtain and provide location information based on the settings. For example, if the granularity was set to P1 or country the policy checker 201 would allow the release of “USA” to the application 210.

The granularity template parameters may also include a recipient associated with a particular granularity such that applications or people that request location information may be provided with a specified granularity. In a “contact list” type application, a users policy might say that the location engine 202 may share/provide user location information at a granularity of City (e.g. Portland) with a colleague in another city who has a granularity setting of Street Address (e.g. 2111 NE 25th Ave, Portland, Oreg.). Also a granularity setting may allow sharing of information in a user group or in this case with the colleague's friend. The user's policy statement could look like: ALLOW (Bob, P1), ALLOW (Carol, P2). Here P1 & P2 could be shared with or populated from the user's granularity template.

The context provider 208 may expose an interface to applications that requests context information such as a platform's location, something about the equipment or something about the user, or something about the user's activities to name a few examples. The context provider 208 may mediate requests and responses between the applications 210 and policy checker 206. The context provider 208 may maintain confidentiality and integrity for interactions with the applications 210 and the policy checker 206. The policy configurator 204 may be implemented as a graphical user interface that provides a single interface to configure the user's policies including the granularity template.

It can be appreciated that the disclosed architecture operates on a user configurable or user selectable policy. The policy may provide graphical controls such as the sliding controls commonly utilized by browsers for Internet security settings. The system 200 may also provide a default setting. The user configured security/privacy policy, may utilize pull down menus and based on these user settings the context provider may release or not releases sensitive location information in compliance with user's privacy preferences including special instructions for known recipients and classes of recipients or authorized users. Users may map these user groups to the granularity of location information by entering information into a table format.

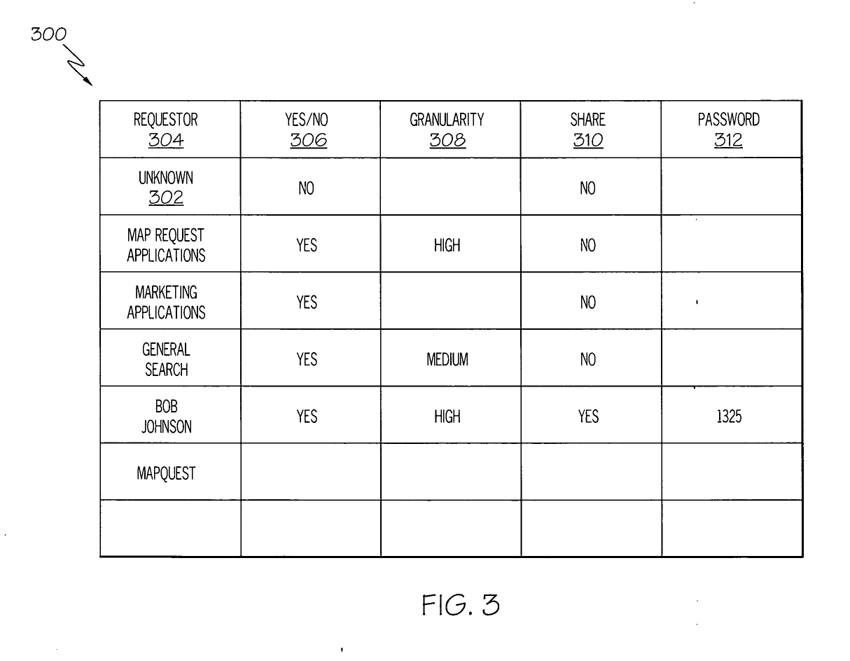

Referring to FIG. 3 a table that illustrates a user privacy selection for a location-aware system is disclosed. A first column, 304 titled “requester” may define an application, a service or an individual that may request location information from a location engine. Column 306 may provide a basic gate keeper function where specific requestors may be excluded from accessing the location information, column 308 may define granularity for each user, column 310 may define whether the requestor should be allowed to share the granularity information with others and column 312 may define a password that allows a requestor to access the subject location information. It may be seen that unknown or unrecognized requestors may be completely excluded or blocked from receiving or accessing location information from the system.

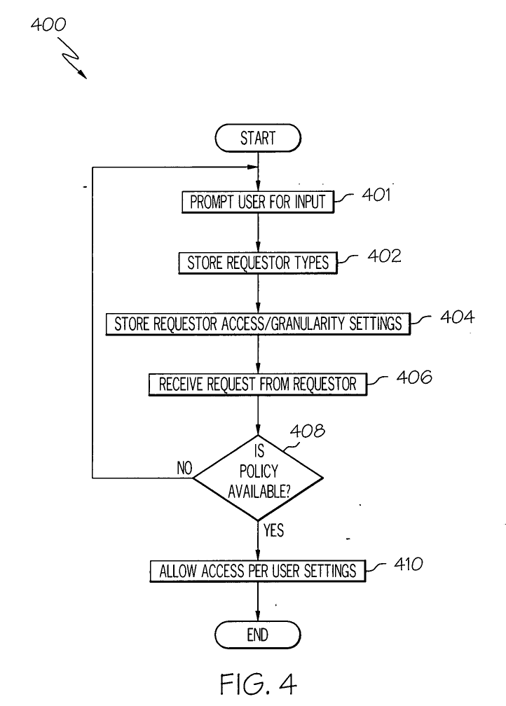

Referring to FIG. 4, a flow diagram of a method for controlling the treatment of location information on a computing platform is disclosed. As illustrated by block 402, a user may be prompted for input regarding treatment of a requester. As illustrated by block 404, the user may provide, and the system may store security settings including a granularity setting based on the requestor. A request for outside access to location information may be received, as illustrated by block 406. As illustrated by decision block 408, the policy may be checked to see if a policy is in place and as illustrated in block 410 the request may be addressed or handled and allow access per the user policy settings. When the policy in not available, the system may revert to block 401 where the user may be prompted for a user input for a privacy setting for the requester and the system may reiterate. The process may end thereafter.

Another embodiment may be implemented as a program product for implementing the arrangements described above. The program(s) of the program product defines functions of the embodiments (including the methods described herein) and may be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of some embodiments of the present invention, and represent some embodiments of the present invention.

In general, the routines executed to implement some of the embodiments of the invention, may be part of an operating system or a specific application, component, program, module, object, or sequence of instructions. The computer program of some of the embodiments of the present invention typically is comprised of a multitude of instructions that will be translated by a computer into a machine-readable format and hence executable instructions.

Also, programs are comprised of variables and data structures that either reside locally to the program or are found in memory or on storage devices. In addition, various programs described hereinafter may be identified based upon the application for which they are implemented in some embodiments. However, it should be appreciated that any particular program nomenclature that follows is used merely for convenience, and thus the some embodiments should not be limited to use solely in any specific application identified and/or implied by such nomenclature.

It will be apparent to those skilled in the art having the benefit of this document that some embodiments contemplate methods and arrangements to control privacy for a location aware system. It is understood that the form of the embodiments shown and described in the detailed description and the drawings are to be taken merely as examples. It is intended that the following claims be interpreted broadly to embrace all the variations of the example embodiments disclosed.

Although some of the embodiments and some of their advantages have been described in detail for some embodiments, it should be understood that various changes, substitutions and alterations may be made herein without departing from the spirit and scope of the invention as defined by the appended claims. Although some embodiments of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification.

As one of ordinary skill in the art will readily appreciate from this document processes, machines, manufacture, compositions of matter, means, methods, or steps, presently existing or later to be developed that perform substantially the same function or achieve substantially the same result as the corresponding embodiments described herein may be utilized according to this document. Accordingly, the appended claims are intended to include within their scope such processes, machines, manufacture, compositions of matter, means, methods, or steps.

What is claimed is:

1. A method comprising:
identifying a requestor;
assigning a privacy setting to share context information with the requester;
detecting a request for the context information from the requestor; and
transmitting the context information to the requestor based on the privacy setting.

2. The method of claim 1, wherein the context information is location information.

3. The method of claim 1, further comprising scanning multiple channels for multiple network identification signals.

4. The method of claim 1, further comprising prompting a user for a privacy setting of sharing context with the requester.

5. The method of claim 1, wherein the requestor is one of a local or remote application or service.

6. The method of claim 1, wherein the requester is one of a user group and an individual.

7. The method of claim 1, further comprising modifying a granularity of the context information based on the privacy setting.

8. The method of claim 1, wherein the requestor is granted access to the location information based on credentials.

9. The method of claim 1, wherein the privacy setting further comprises a granularity setting that is related to the requestor.

10. A system comprising:
a privacy configurator to accept user input regarding user selectable privacy settings regarding treatment of location data, the privacy settings having a requestor and a requestor-specific privacy setting;
a requestor identifier to identify a requestor of the location data; and
a policy checker to control access to the location data based on the user input.

11. The system of claim 10, further comprising a graphical user interface module to accept user input and to display the user selectable privacy settings.

12. The system of claim 10, further comprising a location engine module to determine location data.

13. The system of claim 10, further comprising an application type requestor to request location data from the location engine.

14. The system of claim 10, wherein the policy checker to modify the location information based on the requestor and the granularity.

15. The system of claim 10 further comprising a policy checker to filter location data requests based on a requestor and granularity.
